(19) United States
(12) Patent Application Publication
(10) Pub. No.: US 2025/0144453 A1
(43) Pub. Date: May 8, 2025

(54) A MASK

(71) Applicant: GLOBUS (SHETLAND) LIMITED, Greater Manchester (GB)

(72) Inventor: Joshua MOFFAT, Greater Manchester (GB)

(21) Appl. No.: 18/837,385

(22) PCT Filed: Feb. 2, 2023
(86) PCT No.: PCT/GB2023/050234

§ 371 Date: Aug. 9, 2024

(30) Foreign Application Priority Data
Feb. 10, 2022 (GB) 2201741.2

(51) Int. Cl. A62B 18/08; A62B 18/02; A62B 18/10

(52) U.S. Cl. CPC A62B 18/084; A62B 18/025; A62B 18/10

(57) ABSTRACT

The present application provides a system for coupling a harness strap (302) to a respirator mask, comprising a first coupling element (304) attachable to a harness strap for securing a respirator mask to a wearer: and a second coupling element (326) fixed with respect to the respirator mask and configured to releasably engage with the first coupling element to couple the harness strap to the mask, wherein the first coupling element is rotatable about an axis of the second coupling element and said rotation is limited by a stop arrangement (328).

The present invention relates to a mask and in particular, but not exclusively, to a respirator mask for protecting the wearer from inhaling hazardous atmospheres, including fumes, vapours, gases and particulate matter such as dusts and airborne microorganisms.

Conventional respirator masks typically include an orinasal portion which seals against the face and around the nose and mouth of a wearer. Such masks also typically include an exhalation valve located proximal to the mouth to allow air to flow out of the orinasal portion when the wearer exhales. The respirator mask may also include a pair of inhalation valves each located on the side of the orinasal portion to allow air to enter the mask when the wearer breathes in. A filter assembly is typically associated with each inhalation valve to filter the air and capture any potentially harmful particulates before the air enters the orinasal portion and is inhaled by the wearer. Each valve typically includes a flexible disc-shaped diaphragm valve element supported across a valve orifice provided in the orinasal portion of the respirator mask. The valve element is typically constrained at its centre and supported by a number of spaced apart ribs extending from a central region to the edge of the orifice. The outer region of the valve element seals against a circular valve seat surface surrounding the orifice when the valve element is in a closed position and flexes from the closed position to an open position when a pressure differential is applied across the valve when the wearer exhales or inhales depending on whether the valve is an exhalation valve or an inhalation valve.

However, conventional valve orifice configurations provide a relatively obstructed pathway to air flowing through the valve in use and can undesirably cause air flow resistance and turbulence and in turn discomfort to the wearer. Furthermore, the apertures defined between the ribs extending across the valve orifice are relatively large which can undesirably result in the flexible valve element being urged beyond the closed position and ultimately causing fatigue and/or failure of the valve element itself.

Furthermore, conventional respirator masks also include straps for securing the mask to at least the head, and often also to the neck, of the wearer. These straps typically attach to a body of the mask, such as the orinasal portion of a half-face mask or to a frame surrounding a lens/window of a full-face mask. However, the attachment points are typically fixed or provide 360 degrees of rotation in a single plane which offers no or particularly limited adjustability and provide no means for fitting the mask to the wearer in an optimum position for maximum comfort. In addition, the strap systems of conventional masks are prone to over-rotating and becoming tangled or misaligned when not in use, such as when being stored or transported, which can be time consuming and frustrating for the wearer when attempting to fit the mask.

Additionally, the strap systems of conventional respirator masks are sometimes adjustable in length via a buckle located proximal to the side of the face, however these buckles can often cause discomfort to the wearer and excess strap material can undesirably fall or hang into the wearer's line of sight during use.

It is an aim of certain embodiments of the present invention to address one or more of these problems.

It is an aim of certain embodiments of the present invention to provide a system for coupling a harness strap to a respirator mask, wherein the system provides a limited amount of rotation of the strap with respect to the mask to allow some tolerance between the mask and the strap for adjustability and comfort, whilst preventing the straps becoming tangled or misaligned when the mask is not in use.

It is an aim of certain embodiments of the present invention to provide a system for efficiently coupling and decoupling a harness strap to and from a respirator mask in a non-complex and efficient manner, particularly when wearing gloves and/or in a relatively cold environment.

According to a first aspect of the present invention there is provided a system for coupling a harness strap to a respirator mask, comprising:
a first coupling element attachable to a harness strap for securing a respirator mask to a wearer; and
a second coupling element fixed with respect to the respirator mask and configured to releasably engage with the first coupling element to couple the harness strap to the mask,
wherein the first coupling element is rotatable about an axis of the second coupling element and said rotation is limited by a stop arrangement.

Optionally, said rotation is limited to 65-85 degrees.

Optionally, the first coupling element comprises an aperture for receiving an elongate projecting element of the second coupling element.

Optionally, the aperture comprises a receiving region for receiving an enlarged head portion of the projecting element and a locating region extending from the receiving region for locating an elongate body portion of the projecting element.

Optionally, the locating region is configured to laterally constrain the first coupling element with respect to the projecting element whilst allowing the first coupling element to rotate with respect to the projecting element.

Optionally, the locating region and a cross section of the elongate body portion of the projecting element are substantially circular and have substantially equal diameters to allow for said rotation whilst constraining the same laterally.

Optionally, a width of an opening into the locating region from the receiving region is less than the diameter of the elongate body portion of the projecting element to provide a snap-fit coupling mechanism between the first coupling element and the second coupling element.

Optionally, the head portion of the projecting element is substantially curved in profile.

Optionally, the head portion comprises an inclined upper surface.

Optionally, a forward region of an under surface of the head portion is oriented substantially parallel with the inclined upper surface.

Optionally, a rear region of the under surface is oriented substantially parallel with a bearing surface from which the projecting element perpendicularly extends.

Optionally, a thickness of the first coupling element substantially equals a distance between the rear region of the under surface of the head portion and the bearing surface.

Optionally, the receiving region of the aperture is substantially trapezoidal in symmetrical profile and tapers inwardly towards the locating region.

Optionally, the receiving region has a width substantially equal to a width of the head portion.

Optionally, the aperture comprises a slotted region for receiving an end region of a harness strap and disposed adjacent to the receiving region.

Optionally, the stop arrangement comprises an arcuate recess defining a stop surface at each opposed end thereof, and a stop portion moveable along the recess and engageable with each stop surface responsive to a direction of rotation of the first coupling element.

Optionally, the first coupling element comprises the recess and the stop portion comprises a projection fixed with respect to the respirator mask.

According to a second aspect of the present invention there is provided a respirator mask comprising a system according to the first aspect of the present invention and at least one harness strap for securing the mask to a wearer.

Optionally, the mask comprises a valve cover assembly removably mounted over an exhalation valve of the mask and comprising the second coupling element of the system.

Optionally, the valve cover assembly comprises the second coupling element at each of four corner regions thereof, and the at least one harness strap comprises a head strap assembly connected or connectable to an upper pair of the second coupling elements and a neck strap assembly connected or connectable to a lower pair of the second coupling elements.

Optionally, the valve cover assembly comprises a full-face lens and a substantially flexible sealing portion extending around an outer edge region of the lens for sealing engagement with a wearer's face and comprising the second coupling element.

Optionally, the second coupling element extends away from the lens from each of five spaced apart locations around the sealing portion comprising a pair of upper side locations, a pair of lower side locations, and an upper location disposed substantially on a sagittal plane of the mask.

### DESCRIPTION OF THE DRAWINGS

Certain embodiments of the present invention will now be described with reference to the accompanying drawings in which:

FIG. 1 illustrates an isometric front view of a half face respirator mask according to certain embodiments of the present invention with an exhalation valve cover fitted;

FIG. 2 illustrates a rear sectional view through the orinasal portion of the respirator mask of FIG. 1;

FIG. 3 illustrates an isometric front view of the respirator mask of FIG. 1 with the exhalation valve cover removed;

FIG. 4 illustrates an isometric front close-up view of the exhalation valve orifice of the respirator mask of FIG. 1 with an exhalation valve element of the valve removed;

FIG. 5a illustrates the underside of a first coupling element of a harness coupling system according to certain embodiments of the present invention;

FIG. 5b illustrates a second coupling element of the harness coupling system which is engageable with the first coupling element of FIG. 5a;

FIG. 5c illustrates a cross section through the harness coupling system wherein the first coupling element is coupled to the second coupling element;

FIG. 6a illustrates a harness coupling system according to an alternative embodiment of the present invention for a full-face respirator mask;

FIG. 6b illustrates a first coupling element of the harness coupling system of FIG. 6a;

FIG. 6c illustrates a second coupling element of the harness coupling system of FIG. 6a;

FIG. 6d illustrates a cross section through the harness coupling system of FIG. 6a wherein the first coupling element is coupled to the second coupling element;

FIG. 7a illustrates a head strap assembly according to certain embodiments of the present invention;

FIG. 7b illustrates a coupling member of the head strap assembly of FIG. 7a;

FIG. 7c illustrates a head engagement member of the head strap assembly of FIG. 7a; and

FIG. 7d illustrates a cross section through the head strap assembly of FIG. 7a.

### DETAILED DESCRIPTION

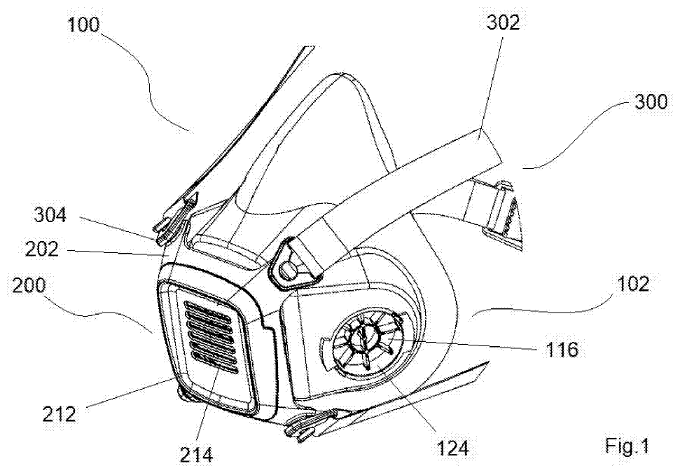

As illustrated in FIG. 1, a respirator mask 100 according to certain embodiments of the present invention includes a substantially flexible orinasal portion 102 for sealingly engaging against the face and around the nose and mouth of a wearer, a valve cover assembly 200 coupled to the orinasal portion 102, and a harness system 300 coupled to the valve cover assembly 200 for securing the mask to the head and neck of the wearer. Aptly, the orinasal portion 102 is a one-piece component moulded from a thermoplastic elastomer (TPE) or the like.

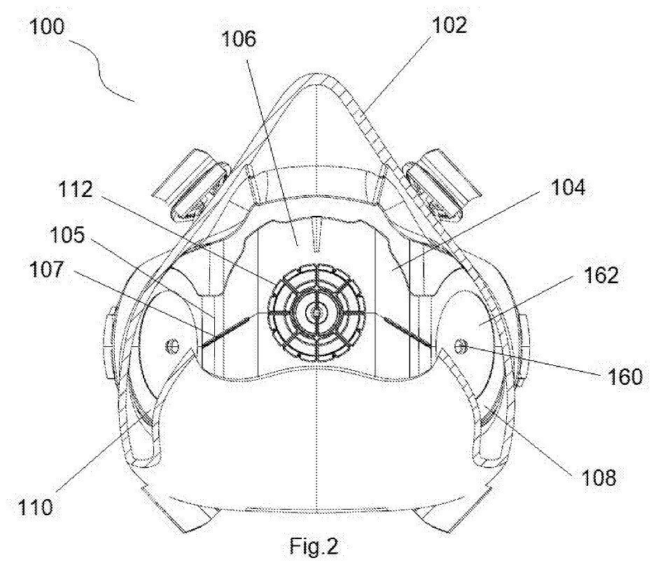

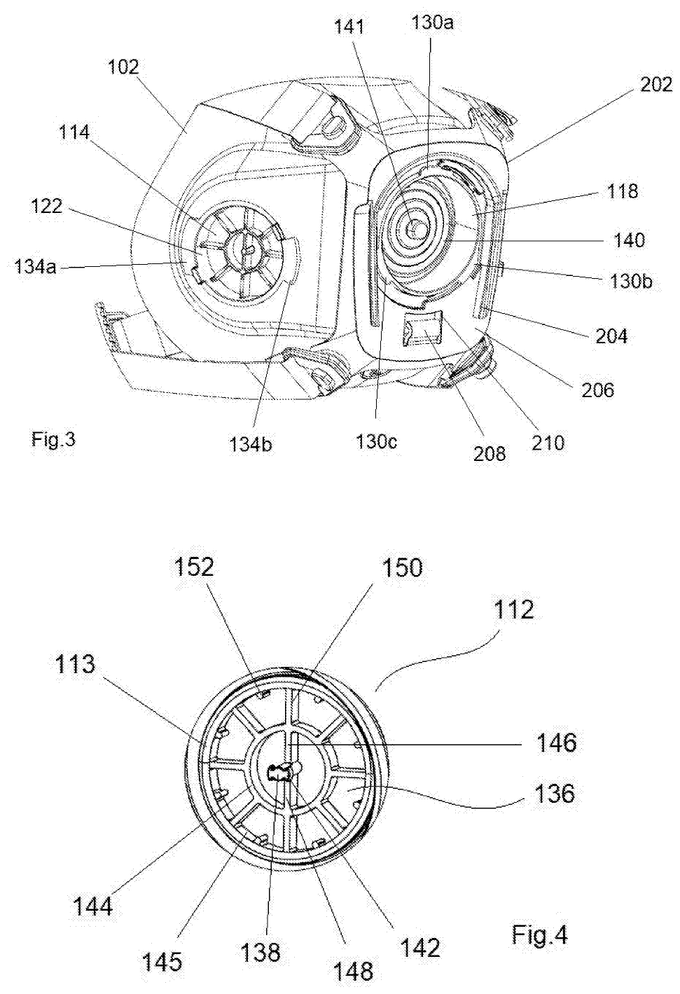

As illustrated in FIG. 2, a relatively stiff support member 104 is located inside the flexible orinasal portion 102 to add structure and strength to the orinasal portion and prevent the same from collapsing. Aptly, the support member 104 is a one-piece component moulded from a polycarbonate acrylonitrile butadiene styrene (ABS) blend or the like. The support member 104 defines a central region 106 located between two side regions 108,110. The side regions 108,110 are angled rearwardly by around 30 degrees with respect to the central region 106, i.e. defining an internal angle of around 150 degrees, to engage with and support the respective inner surfaces of the orinasal portion 102. The bend lines 105 allow the side regions to flex slightly with respect to the central region to provide some resilience during storage, transport and use, whilst an optional strengthening rib 107 across each bend line adds stiffness to limit the amount of flex. The central region 106 of the support member 104 includes an exhalation orifice 112 and, as illustrated in FIGS. 1 and 3, each side region 108,110 includes an inhalation orifice 114,116.

As illustrated in FIGS. 1 and 3, a substantially circular central wall region 118 extends forwardly from the central region 106 of the support member 104 and extends through a correspondingly shaped aperture in the orinasal portion 102. Likewise, a substantially circular side wall region 122,124 extends forwardly from the respective side region 108,110 of the support member 104 and through a respective aperture provided in the orinasal portion 102. Each wall region defines a cylinder shape and the central wall region is longer, i.e. extends further, than each side wall region.

The central wall region 118 of the support member 104 includes three projections 130a, 130b, 130c equally spaced apart around a forward edge of the central wall region 118 to provide a first part of a bayonet connection for releasably coupling a valve cover support portion 202 of the valve cover assembly 200 to the support member 104 of the orinasal portion 102 and over the exhalation orifice 112. Each of the side wall regions 122,124 of the support member 104 includes a pair of opposed projections 134a, 134b extending outwardly from an outer edge of the respective side wall region to provide a first part of a bayonet connection for releasably coupling a filter assembly (not shown) to each of the side wall regions for fluid communication with a respective one of the inhalation orifices 114,116.

The valve cover support portion 202 includes a pair of laterally spaced apart rails 204 provided on a forward-facing surface 206 of the valve cover support portion such that the central wall region 118 defining the exhalation orifice 112 is located between the two rails when the valve cover support portion is mounted on the orinasal portion 102. A resilient element 208 is provided in an aperture 210 formed in the forward-facing surface 206 of the valve cover support portion which engages with a corresponding recess provided in a rear-facing surface of a valve cover member 212 as shown in FIG. 1. The valve cover member 212 includes corresponding grooves or channels for receiving the rails 204 to allow the cover member to be slideably mounted up and on to the valve cover support portion 202 whilst being constrained in the forward direction by the interlocking engagement between the rails and grooves/channels. A projecting region of the cover member 212 is forced over a curved surface of the resilient element 208 which projects beyond the forward-facing surface 206 of the valve cover support portion 202 and urges the resilient member to flex into the aperture 210 before resiliently returning to its original position and behind the projecting region of the valve cover member to thereby secure the valve cover member 212 to the valve cover support portion 202 and prevent it sliding downwardly. In view of the resilience of the resilient element 208, the valve cover member 212 can be manually urged downwardly with respect to the valve cover support portion 202 and in turn the projecting region of the valve cover member 212 is urged back over the projecting surface of the resilient element 208 to thereby remove the valve cover member 212 from the valve cover support portion 202 if/when desired, such as to clean and maintain the exhalation valve and/or valve cover member. As illustrated in FIG. 3, the valve cover member 212 includes a plurality of slots 214 for allowing air to flow through the same when the wearer exhales via the exhalation valve. Alternatively, the valve cover member 212 and the valve cover support portion 202 may be integrally formed such that the valve cover assembly is a one-piece component removably mounted over the exhalation valve of the orinasal portion.

### Valve Support Structure

As illustrated in FIG. 4, the exhalation orifice 112 includes a support structure 136 for supporting a substantially flexible disc-shaped diaphragm valve element (referenced 140 in FIG. 3) which seals around its peripheral edge region against a forward-facing circumferential seal surface 113 surrounding the orifice when the valve element 140 is in a closed position. In use, the peripheral edge region of the valve element 140 flexes outwardly and away from the seal surface 113 towards an open position when a pressure differential is created across the exhalation valve when the wearer exhales. This one-way valve arrangement prevents potentially harmful particles entering the orinasal portion when the wearer inhales. The support structure 136 extending across the exhalation orifice 112 supports the valve element 140 across its diameter when in the closed position and prevents the same being pulled through the orifice, i.e. overclosure of the valve element, when a pressure difference is applied across the valve when the wearer inhales. Alternatively, the valve element may be substantially square or hexagonal or the like, for engaging with a correspondingly shaped seal surface, whilst still being mounted centrally with respect to the valve orifice to act as a diaphragm valve element.

The support structure 136 includes a central projection 138 disposed on a central axis of the orifice and which engages in a bore of a central boss 141 of the valve element 140 to securely locate the same on the support structure and over the exhalation orifice 112. The central projection 138 includes a pair of lugs 142 which outwardly extend substantially perpendicularly in opposed directions from the free end of the projection 138. These lugs locate within an undercut region of the bore in the valve element to secure the same to the projection and prevent the valve element from being forced off the projection when the wearer exhales. The resilient material of the valve element 140 allows the lugs to be urged into the bore of the central boss 141 whilst providing sufficient security when located on the central projection 138 and also allowing the valve element to be manually pulled from the projection when removal is required or desired for cleaning or replacement. The central boss 141 which extends forwardly when the valve element is in situ on the central projection 138 of the support structure 136 provides a form of handle for a user to grip between their thumb and index finger when removing/fitting the valve element 140 from/to the projection 138 respectively. This arrangement is particularly desirable in view of the central wall region 118 of the support member 104 being deeper than the side wall regions 108,110 which could otherwise make manual installation and/or removal of the exhalation valve element 140 difficult.

As illustrated in FIG. 3, the disc-shaped and flexible exhalation valve element 140 comprises a tiered outer surface wherein the innermost tier is located forward of the outermost tier. The rear surface of the valve element is similarly tiered and each tier is substantially the same thickness. This arrangement desirably provides radially spaced circular hinge lines between the centre and outer edge of the valve element to maximise its efficiency and responsiveness when opening and closing with respect to the seal surface 113 in use. Alternatively, the exhalation valve element may be substantially flat on both surfaces like the illustrated inhalation valve elements or the inhalation valve elements may take the same or similar form as the illustrated exhalation valve element.

The support structure 136 further includes a support ring 144 which is coaxial with the central projection 138 and located approximately midway between the central projection 138 and the inner surface 145 of the orifice. A pair of inner elongate support portions 146,148 extend in opposed directions from the base of the central projection 136 to the support ring 144 and are integrally formed therewith. The inner support portions 146,148 are disposed on a diametral axis of the orifice, i.e. they are axially aligned and diametrically opposed to each other. Alternatively, a single inner support portion may be provided to integrally couple the central projection to the support ring and support the same in the centre of the valve orifice. However, a pair of diametrically opposed inner support portions aptly provides secure and balanced support to the central projection 138 and to support each half of an inner region of the valve element 140 when in the closed position. Further alternatively, the support ring 144 may not be substantially circular as illustrated, and may be a different shape to correspond with a shape of the diaphragm valve element such as hexagonal, pentagonal, octagonal, or square, for example. Desirably, a substantially circular support ring provides an optimum amount of support to a mid-region of the disc-shaped valve element whilst minimising the resistance to air flowing through the valve in use.

Eight primary outer elongate support portions 150 extend from the support ring 144 to the inner surface of the orifice wall which defines the valve orifice. The primary outer support portions 150 are equally spaced apart by 45 degrees wherein the first (12 o'clock) and fifth (6 o'clock) primary outer support portions are disposed on the diametrical axis to be axially aligned with the inner support portions 146,148. More or less primary outer support portions may be provided depending on the size of orifice but eight equally spaced support portions provide effective support to the outer region of the valve element to prevent overclosure thereof, whilst minimising air flow resistance and turbulence, particularly for an orifice having a diameter of around 25-30 mm. For example, the support ring 144 may be substantially octagonal and a primary outer support portion may extend outwardly from each corner of the support ring to the inner surface of the orifice wall.

A secondary outer support portion 152 is provided substantially midway between each adjacent pair of the primary outer support portions 150 and is in the form of a relatively short projection, such as a nib, extending only partially towards the support ring 144. A forward-facing surface of each secondary outer support portion 152 is substantially coplanar with the forward-facing surface defined by the support ring 144 and the primary outer support portions 146,148,150. Aptly, the coplanar forward-facing surfaces of the support structure 136 are coplanar with the seal surface 113 against which the valve element 140 engages when in the closed position. Each secondary outer support portion 152 is around 15-20% the length of each primary outer support portion 150, i.e. the primary outer support portions are around 75-80% longer than the secondary outer support portions 152. Each secondary outer support portion 152 comprises a curved end surface to reduce the turbulence effects thereof and to eliminate any sharp corners which could otherwise compromise the integrity of the valve element in use.

In use, the inner support portions 146,148 of the support structure 136 support an inner region of the diaphragm valve element 140 when in the closed position and prevent the same being forced beyond the closed position when the wearer inhales. The support ring 144 supports a mid-region of the valve element and the primary outer support portions 150 support an outer region of the valve element. The secondary outer support portions 152 provide additional support to the outer edge region of the valve element 140 to prevent overclosure and without compromising the flow of air through the valve when the wearer exhales. The configuration of the support structure 136 according to certain embodiments of the present invention maximises the opening area across the orifice for maximum airflow through the valve, whilst minimising airflow resistance of the support portions located in the path of the airflow, and maximises the support of the valve element across the entire diameter of the valve element from its centre to its outer edge region to prevent overclosure and also fatigue and failure in use. In turn, a wearer's experience in terms of breathing efficiency is improved and their comfort maximised.

As illustrated in for example FIG. 3, the inhalation orifices 114,116 each include a substantially identical, or at least similar, support structure for supporting a respective inhalation valve element (not shown) in substantially the same way as in the exhalation valve described above. As illustrated in FIG. 2, the central projection of each inhalation valve support structure extends inwardly into the interior region defined by the orinasal portion 102 and includes an enlarged circular head region 160 over which a central hole in the respective inhalation valve element 162 is located. The central hole in each inhalation valve element 162 has a diameter which is less than the head region 160 of the central projection to retain the same with respect to the inhalation orifice. The flexibility and resilience of the valve element material allows the valve element 162 to be urged over the head region 160 when fitting or removing the valve element. Each inhalation valve element 162 is a flexible sheet-like disc which can be easily removed from inside the orinasal portion 102 for cleaning or replacement.

### Harness Coupling System

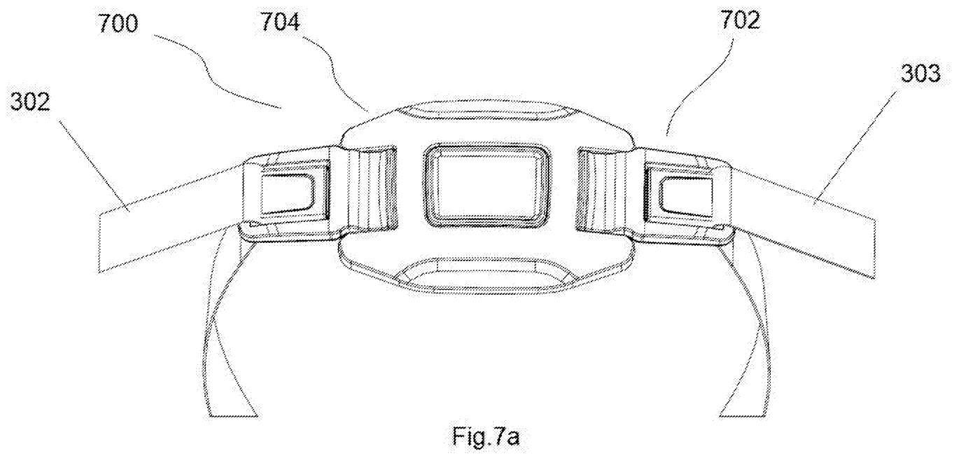

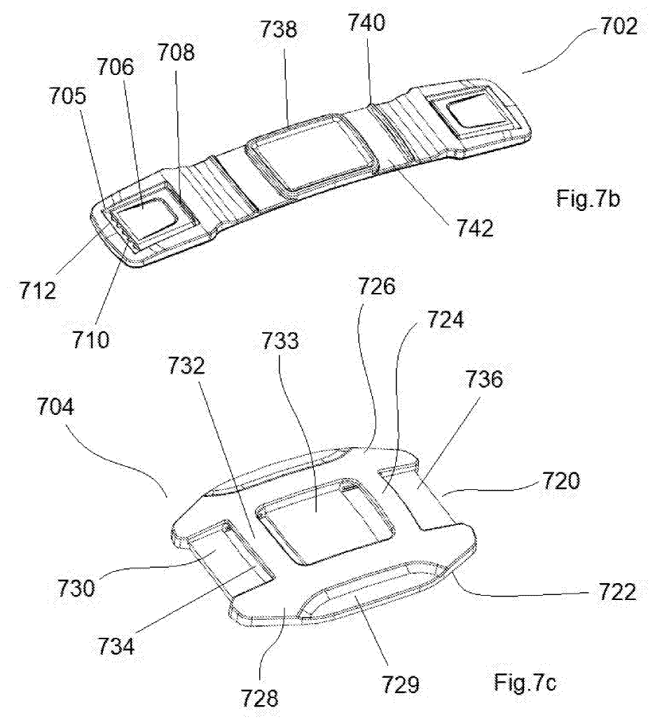

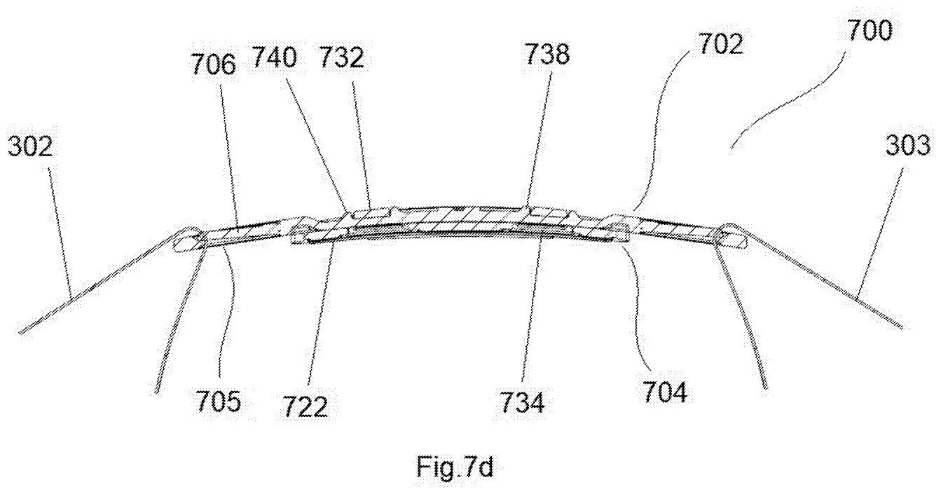

As illustrated in FIG. 1, four straps 302 of the harness system 300 of the respirator mask 100 each couple to a respective corner region of the valve cover support portion 202 via a coupling element 304. The two upper straps are coupled together at their free ends by a head pad assembly 700 (as illustrated in FIG. 7a) for securing the mask to the head of a wearer, whilst the lower two straps are coupled together at their free ends by a buckle/clip arrangement (not shown) for securing the mask to the neck of the wearer.

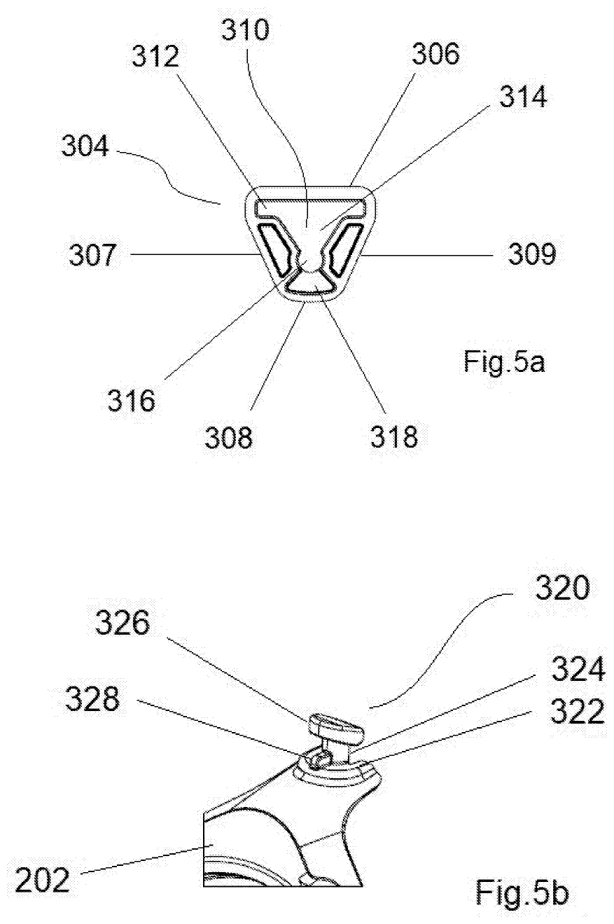

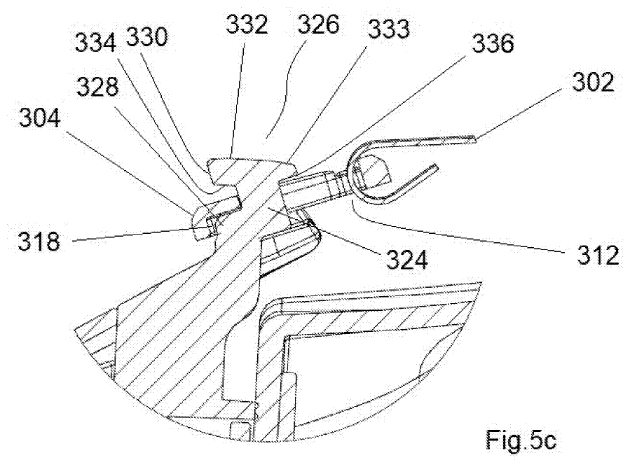

FIG. 5a illustrates the underside of one of the coupling elements 304. Each coupling element 304 is substantially trapezoidal, i.e. a triangle with a flat apex, in profile defined by a relatively wide end region 306, a relatively narrow end region 308 opposite the wide end region, and a pair of opposed and angled side regions 307,309 extending between the wide end regions and the narrow end region. The coupling element 304 includes a substantially triangular and symmetrical aperture 310 including a slotted region 312 disposed proximal to and parallel with the wide end region of the coupling element for receiving an end region of a respective strap. The end region of the strap can be fed through the slotted region 312, returned back on itself and fixed, such as by stitching, to the body of the strap to thereby securely attached the strap to its respective coupling element 304, as illustrated in FIG. 1. The length of the slotted region 312 substantially corresponds to a width of the strap to prevent the strap moving laterally in the slotted region.

The aperture 310 further includes a substantially trapezoidal receiving region 314 extending from the slotted region 312 and defined by angled sides which taper inwardly towards the narrow end region 308 of the coupling element 304. The tapered sides of the receiving region 314 start inboard of the ends of the slotted region 312 which prevents the strap migrating into the receiving region from the slotted region. The aperture 310 further includes a substantially circular locating region 316 in communication with the receiving region 314. A width of the opening into the locating region 316 from the receiving region 314 is slightly less than a diameter of the locating region. FIG. 5a illustrates the underside of the coupling element 304 and shows a dovetail-shaped recess 318 formed in an under surface of the coupling element and proximal to the narrow end region 308 of the coupling element 304. The dovetail-shaped recess 318 extends from the locating region 316 of the aperture 310 such that the sides of the recess taper outwardly towards the narrow end region 308.

As illustrated in FIG. 5b, each corner region of the valve cover support portion 202 includes a projecting element 320 extending outwardly and substantially perpendicularly from a substantially flat bearing surface 322. The projecting element 320 comprises an elongate body portion 324 having a substantially circular cross section and an enlarged head portion 326 which has a substantially circular cross section. Alternatively, either or both of the body portion and head portion of the projecting element may have an oval cross section wherein a major axis thereof is directed forwardly, i.e. away from a wearer in use. An elongate stop portion 328 in the form of a rib extends forwardly along the bearing surface 322 from the base of the body portion 324.

As illustrated in FIG. 5c, the receiving region 314 of the aperture 310 in the coupling element 304 is sized to receive the head portion 326 of the projecting element 320. However, the size of the head portion 326 and receiving region 314 of the aperture 310 are such that the receiving region 314 of the coupling element 304 will not receive the head portion 326 when the projecting element 320 is oriented substantially perpendicularly to the coupling element 304 and receiving region thereof. The narrow end region (front) of the coupling element must instead be angled downwardly and a front edge region 330 of the head portion located through the receiving region 314 of the aperture 310. The upper surface 332 of the head portion 326 is angled upwardly, i.e. inclined, in the forward direction with respect to the bearing surface 322. A forward region 334, such as half, of the under surface of the head portion is similarly angled upwardly and substantially parallel with the upper surface of the head portion, whilst a rear region 336, such as the other half, of the under surface of the head portion is substantially parallel with the bearing surface 322. At least the angled upper surface 332 of the head portion allows the front region 330 of the head portion to be located through the receiving region 314 of the aperture 310. The angled rear region 333 of the upper surface of the head portion, and aptly a resilience of the strap engaged therewith, then allows the wide end portion of the coupling element 304 to be urged downwardly to force the entire head portion 326 of the projecting element 320 through the receiving region 314 of the aperture 310. Aptly, the rear region 333 of the upper surface of the head portion may be oriented at a steeper angle to the front region of the upper surface of the head portion to facilitate easier locating of the coupling element on to the projecting element.

When the head portion 326 of the projecting element 320 is located through the receiving region 314 of the aperture 310, the coupling element 304 is urged rearwardly to force the cylindrical body portion 324 of the projecting element 320 into the corresponding sized and shaped locating region 316 of the aperture 310. A resilience of the material of the coupling element allows the body portion of the projecting element to be forced through the relatively narrow opening of the locating region 316 from the receiving region 314 of the coupling element. The coupling element 304 may be called a first coupling element and the projecting element 320 may at least form a portion of a second coupling element engageable with the first coupling element 304.

A distance between the bearing surface 322 and the substantially parallel rear region 336 of the under surface of the head portion 326 is substantially the same as a thickness of the coupling element 304 such that when the body portion of the projecting element is snapped into the correspondingly sized and shaped locating region 314 of the aperture 310 in the coupling element 304, the coupling element is constrained on the projecting element 320 in all translational directions but is free to rotate with respect to an axis of the projecting element. The snap-fit relationship between the coupling elements provides a tactile and/or audible indication to the wearer that the respective strap is securely coupled to the mask body.

The stop portion 328 extending from the base of the projecting element 320 limits the amount of rotation of the coupling element by engaging with either end surface of the dovetail-shaped recess 318 in the coupling element. Aptly the rotation track defined by the dove-tailed or actuate recess 318 allows for around 65-85 degrees of rotation. Furthermore, the angled front under surface 334 of the head portion 326 allows a degree of rotation (tilt) with respect to an axis perpendicular to the axis of the projecting element. Such rotation with respect to one or both axes provides some adjustability/tolerance for the wearer which improves comfort.

FIG. 5c shows the coupling element 304 attached to a respective one of the corner regions of the valve cover support portion 202. To decouple the coupling element 304 from the respirator mask, the coupling element 304 is first urged forwardly with respect to the projecting element 320 to force the cylindrical body portion 324 of the projecting element 320 out of the locating region 316 of the aperture 310 and into the receiving region 314 of the aperture. The rear wide end region 306 of the coupling element can then be lifted upwardly to urge the rear edge of the head portion 326 of the projecting element 320 out of the triangular shaped receiving region 316 of the aperture 310 of the coupling element 304. The coupling element is then decoupled from the mask.

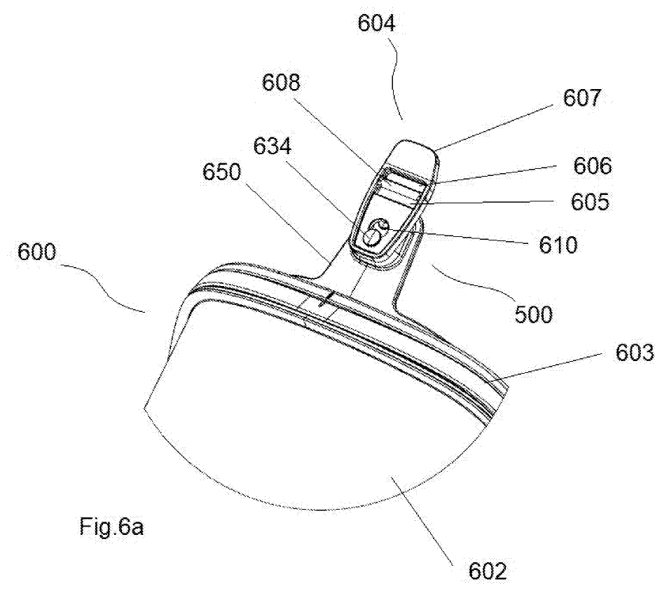

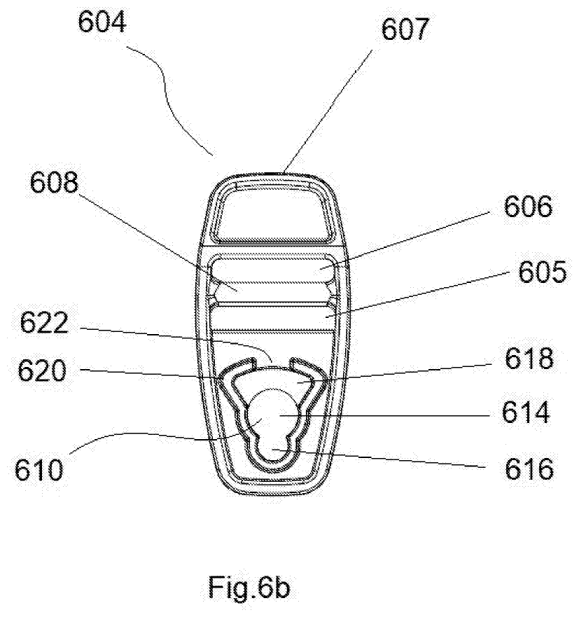

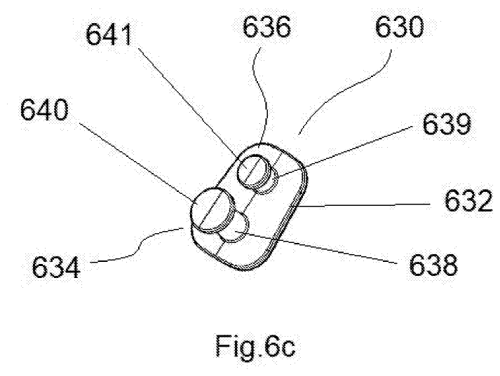

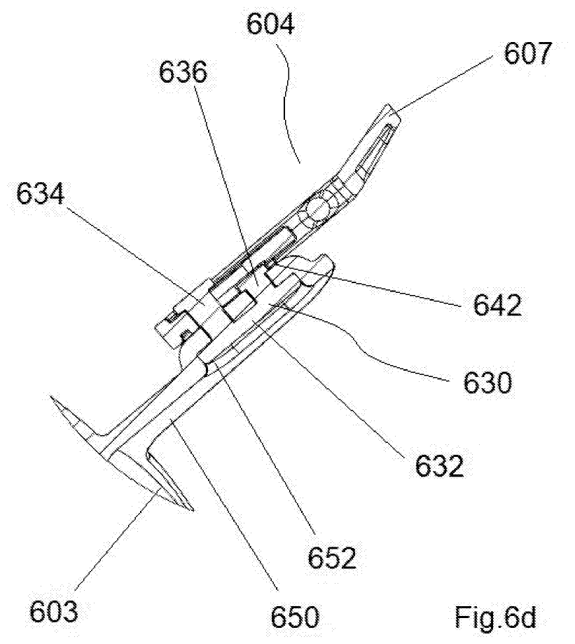

FIG. 6a illustrates an alternative embodiment of a harness/strap coupling arrangement 500 suitable for a full-face respirator mask 600 comprising a substantially rigid and transparent lens or faceguard/window portion 602 secured to a substantially flexible sealing portion 603 for sealing engagement with the face of a wearer.

FIG. 6b illustrates the underside of an elongate first coupling element 604 which includes a pair of slotted through apertures 605,606 disposed proximal to a rear end region 607 of the first coupling element and spaced apart by a laterally extending bar portion 608. A free end region of a strap of a harness system (not shown) can be fed from the underside through the foremost slotted aperture 605, over the bar portion 608 and through the rearmost slotted aperture 606. Friction forces between the strap and the bar and apertures holds the strap in place, particularly when the strap is rubber, with respect to the first coupling element.

The first coupling element 604 further includes a keyhole-like aperture 610 longitudinally spaced apart from the slotted apertures 605,606 and defined by a substantially circular receiving region 614 having a first diameter and a substantially circular locating region 616 having a second diameter, wherein the locating region extends into the receiving region to communicate therewith and the first diameter is greater than the second diameter. A width of the opening into the locating region 616 from the receiving region 614 is slightly less than a diameter of the locating region. A dove-tailed recess 618 defining an arcuate path and opposed end surfaces is disposed adjacent to and extending into the receiving region 614. A wall region 620 follows the periphery of the locating region 616, the receiving region 614 and the dove-tailed recess 618. A gap 622 is provided centrally in the wall region 620 where it follows the relatively wide end of the dove-tailed recess.

As illustrated in FIG. 6c, a second coupling element 630 includes a base portion 632, a first projecting element 634 extending perpendicularly from the base portion, and a second projecting element 636 extending perpendicularly from the base portion and spaced apart from the first projecting element 634. Each projecting element 634,636 includes an elongate body portion 638,639 having a substantially circular cross section and an enlarged head portion 640,641 which also has a substantially circular cross section. The first projecting element 634 is longer/taller than the second projecting element 636. The second coupling element 630 is relatively rigid and stiff and is aptly formed from a plastics material.

As illustrated in FIG. 6d, the second coupling element 630 is located in a correspondingly sized and shaped recess 652 formed in the underside of a flexible lug 650 extending from an upper and central location of the sealing portion 603 of the mask, i.e. substantially on the sagittal plane of a wearer when in use. A pair of similar lugs are also provided on each side of the sealing portion 603 to provide five lugs for a suitable harness system to couple to for securing the full-face respirator mask to the head of a wearer. When assembling the mask, the projecting elements 634,636 of the second coupling element 630 are urged through respective holes in the lug 650 such that second coupling element is received in the recess. The flexible yet resilient properties of the lug material allow the projecting elements to be urged through the respective holes. The distance between an under surface of the head portion 641 of the second projecting element 636 and an outwardly-facing bearing surface 642 of the lug 650 is substantially the same as a thickness of the lug material defining the outer bearing surface 642 and an inner base surface of the recess 652. This arrangement secures the second coupling element 630 in the recess of the lug 650 and ensures it is constrained in all directions with respect to the lug. As illustrated in FIG. 6d, the rear end region 607 of the first coupling element 604 is angled upwardly with respect to the main body of the first coupling element to provide a handle for a wearer/user to grip when attaching/releasing the first coupling element to/from the second coupling element.

To attach the first coupling element 604 to the second coupling element 630, the circular receiving region 614 of the second coupling element is aligned with and located over the correspondingly shaped head portion 640 of the first projecting element 634 in substantially an axial direction with respect to the projecting element. In other words, the head portion 640 of the first projecting element 634 is received in and passes through the receiving region 614 of the aperture 610 in the first coupling element 604. The gap 622 between the ends of the wall region 620 accommodates the head portion 641 of the second projecting element 636 when the first coupling element 604 is initially located on the first projecting element 634. If the first coupling element is slightly misaligned with respect to a longitudinal axis of the lug, the head of the second projecting element 636 will engage with the wall region 620 and rotation of the first coupling element to align the same with the axis of the lug, and in turn the head portion of the second projecting element with the gap in the wall region, will result in the head portion locating in the gap which will provide a tactile indication to the user that the first coupling element is correctly aligned with the second coupling element.

The first coupling element 604 is then urged rearwardly, i.e. away from the sealing portion 602 of the mask, such that the cylindrical body portion 638 of the first projecting element 634 is urged towards and snaps into the circular locating region 616 of the aperture 610. In turn, the head portion 641 of the second projecting element 636 is located in the dove-tailed recess 618 of the first coupling element 604. A distance between an underside of the head portion 640 of the first projecting element 634 and the upper/outer bearing surface 642 of the lug 650 is substantially equal to a thickness of the first coupling element 604. The first coupling element 604 is now constrained in all translational directions whist being rotatable about the first projecting element 634. The rotation is limited in both directions by the ends of the dove-tailed recess of the first coupling element engaging with the head portion of the second projecting element. Aptly the rotation track defined by the dove-tailed or actuate recess 618 allows for around 65-85 degrees of rotation. Whilst this coupling arrangement may be configured to allow the first coupling element to tilt with respect to the second coupling element, as described above in relation to the embodiment illustrated in FIGS. 5a to 5c, the lugs 650 are sufficiently flexible to provide this tolerance for improved comfort.

The harness coupling arrangement described above and illustrated in FIGS. 6a to 6d may alternatively be suitable for use on a half-face respirator mask. Likewise, the harness coupling arrangement described above and illustrated in FIGS. 5a to 5c may alternatively be suitable for use on a full-face respirator mask.

Each harness coupling arrangement provides a secure means of coupling a harness system to a respirator mask whilst also providing a quick-release mechanism for efficiently decoupling the harness system from the mask if required, such as for cleaning or maintenance purposes or to fit a differently configured harness system to the mask including the same/suitable coupling elements for attaching the harness system to the mask. The harness coupling arrangements are configured to allow but limit rotation of a buckle component attaching a strap of a harness system to the mask body to thereby allow the angle of each harness strap with respect to the mask body to be adjusted independently when in use whilst preventing the straps of the harness system becoming tangled or misaligned when not in use.

### Head Strap Assembly

As described above, a harness system for securing a mask, such as a half-face respirator mask, may include one or more straps for securing the mask to the head of a wearer.

As illustrated in FIG. 7a, a head strap assembly 700 according to certain embodiments of the present invention includes an elongate coupling member 702 for coupling together the free end regions of a pair of opposed head straps 302,303 each extending from a respective side of the mask body, such as from respective sides of the valve cover support member 202 as illustrated in FIG. 1. The head strap assembly 700 further includes a head engagement member 704 mounted on the coupling member 702 for engaging the back of the wearer's head. Alternatively, the strap assembly may be a neck strap assembly comprising the elongate coupling member for coupling together the free end regions of a pair of opposed neck straps each extending from a respective side of the mask body, and an engagement member mounted on the coupling member for engaging the back of the wearer's neck.

As illustrated in FIG. 7b, the coupling member 702 includes a substantially square aperture 705 proximal to each end thereof and a tab 706 extending across the aperture from an inboard edge thereof. Each tab 706 is connected to the inboard edge of the respective aperture by a substantially resilient hinge region 708 which allows the tab to be urged outwardly about the hinge region and away from the aperture towards an open position, whilst being returnable to a closed position when no force is being applied to the tab. Alternatively, the tab itself may be substantially resilient to allow some flex whilst returning to the closed position when no force is being applied thereto. An outboard edge 710 of each tab includes a plurality of teeth for gripping a respective one of the straps 302,303. Aptly, the teeth overlap the outboard edge of the aperture such that the teeth would engage the outboard edge of the aperture if the tab was pressed towards the aperture with no strap present therein. Aptly, the outboard edge of the aperture is also toothed and the teeth thereof are aligned with gaps between the teeth of the tab. Aptly, the teeth cannot pass between each other to prevent overclosure of the tab with respect to the aperture. The straps are aptly an elastic fabric material and at least the surface of the strap engageable with the toothed tab comprises a substantially open weave structure for the teeth to locate into for optimum engagement and security. Alternatively, each end region of the coupling member may comprise a different form of adjustable strap grip such as a cam buckle, or a fixed or sliding bar buckle, for example.

As illustrated in FIGS. 7a and 7d, to attach the straps 302,303 to the head strap assembly 700, the free end of each strap 302,303 is fed, from an inner side of the coupling member 702, through a gap between the outboard edge 712 of the respective aperture 705 and the toothed outboard edge 710 of the respective tab 706. The outboard edge 712 of each aperture may be angled to help guide the strap thereover and eliminate any sharp edges which could undesirably compromise the integrity of the strap material during adjustment of the straps in use. An angled edge surface also provides a greater surface area for supporting the strap when the toothed edge is gripping the strap in the closed position. The tab can be manually flexed outwardly to increase the gap if required to feed the end of the strap therethrough. In view of the resilient hinge region 708, pulling the strap through the aperture and against the toothed edge 710 of the respective tab 706 urges the tab to flex towards the open position to increase the gap and allow the strap to be pulled through the aperture by a desired amount depending on the size of the wearer's head for properly securing the mask to their head. In contrast, pulling the strap the other way through the aperture, such as by a reactive force in an elastic strap when the mask is being worn, causes the toothed edge 710 of each tab 706 to bite into the strap and urge the tab towards an over-closed position which decreases the gap and locks the strap in position with respect to the coupling member, i.e. the configuration of the resilient toothed tabs 706 allow for efficient and non-complex adjustment of the straps, whilst preventing slippage of the straps when in a desired position for optimal security and comfort. Furthermore, the head strap assembly 700 according to certain embodiments of the present invention allows the free ends of the straps to be located behind the head of the wearer and therefore eliminates any risk of the free ends of the straps dropping into the wearer's line of vision during use. Aptly, the coupling member 702 and/or the head engagement member 704 may include a first attachment element for releasably attaching to a second attachment element of the straps to releasably attach the free end regions of the straps, which are distal to the mask body, to the head strap assembly 700 to further keep them out of the way during use. For example, the first connector may comprise a magnet mounted on or moulded into the coupling member or engagement member, and each strap may include one or more metallic elements attracted to the magnet, such as a plurality of ferromagnetic elements spaced apart along the length of at least the end region of the strap, for releasable engagement with the magnet. The metallic element/s may be in the form of small sheet-like discs adhered to the strap or located in the strap, or one or more wires extending through the strap like a fibre.

Aptly, the coupling member 702 comprises a one-piece plastics component which is flexible but resilient, and moulded from polypropylene or the like. Its flexibility allows it to conform to the curvature of the back of the wearer's head when the head engagement member 704 is engaged therewith and when the straps are pulled tight to secure the mask to the wearer's face. Aptly, the coupling member is substantially curved along its length in an unstressed state to at least partially conform with the back of a wearer's head before the straps are tightened.

As illustrated in FIG. 7c, the head engagement member 704 is configured to be supported on the coupling member 702 and between the end regions thereof including the strap gripping tabs 706. The head engagement member 704 acts as a head pad and provides a central region of the head strap assembly 700 with an increased width, and in turn surface area, compared to the coupling member 702 for engagement with the wearer's head. An increase in contact surface area provides increased support and grip with the wearer's head, whilst also improving comfort. An inner engagement surface of the head engagement member 704 may include a plurality of projections, such as spaced apart and parallel ribs, for gripping the wearer's head and also providing channels for breathability and airflow to minimise/prevent sweating. Such ribs also provide substantially horizontal hinge regions for the engagement member to flex about and closely conform to the curvature of the wearer's head for optimal comfort and support.

The head engagement member 704 includes an inner portion 720, an outer portion 724 spaced apart from the inner portion 720, and opposed side portions 726,728 to thereby define a slotted channel 730 extending longitudinally through the head engagement member 704 which is in a substantially perpendicular (lateral) direction to the sagittal plane of a wearer when the mask is being worn. The side portions and the inner portion collectively provide an engagement surface 722 for engaging the wearer's head. The slotted channel 730 is sized and shaped to correspondingly receive and locate the coupling member 702 therein such that the coupling member is laterally constrained in channel with respect to a longitudinal axis of the channel. Furthermore, the outer portion 724 of the head engagement member 704 is formed by a pair of longitudinally spaced apart bridge regions 732 extending laterally across the channel 730 which are substantially flexible to allow one of the enlarged end regions of the coupling member 702 to be urged through the channel during assembly of the head strap assembly 700. The bridge regions 732 and the side portions 726,728 define a central aperture 733 therebetween.

Aptly, the head engagement member 704 comprises a one-piece, substantially flexible elastomeric material, such as TPE or the like, which further allows the coupling member 702 to be urged through the channel of the head engagement member 704 to assemble the head strap assembly 700, whilst also allowing the head engagement member 704 to flex with the coupling member 702 to conform closely with the back of the wearer's head in use for optimal comfort, support and security. The head engagement member 704 is substantially more flexible and less stiff than the strap coupling member 702. Aptly, at least an inner engagement surface of the engagement member is substantially curved along its length and across its width, i.e. in both longitudinal and lateral axes, when in an unstressed state to thereby at least partially conform with the backside of a wearer's head before the straps are tightened. Each side portion 726,728 includes an elongate scalloped region 729 extending into the outer surface of the head engagement member 704 and along the respective edge. These scalloped regions 729 allow a wearer to tactilely locate and grip the head engagement member 704 whilst wearing the mask and move the same into a desired position on the backside of their head for optimal comfort and security.

As illustrated in FIG. 7c, the inner portion 720 of the head engagement member 704 includes a pair of longitudinally spaced apart apertures 734 laterally extending across the base of the channel between the two side portions 726,728. These base apertures 734 are aligned with the bridge regions 732 and allow the head engagement member 704 to flex around, i.e. laterally, a central portion of the back of the wearer's head to conform with the curvature of the back of the wearer's head without the inner portion 720 bunching up and causing discomfort to the wearer. Furthermore, the base apertures 734 define three longitudinally spaced apart and laterally extending web regions 736 forming the inner portion 720 each of which are substantially flexible to further aid insertion of the coupling member 702 through the channel 730 during assembly.

As illustrated in FIG. 7b, the coupling member 702 includes a raised boss region 738 located substantially centrally between the two end regions and having a substantially square profile. The boss region 738 extends the full width of the elongate coupling member 702. Alternatively, the boss region may extend partially across the width of the coupling member and/or may be a different shape, such as rectangular, oval or circular. Further alternatively, the boss region may instead be a continuous wall region defining a square, rectangle, oval, circle or the like. The coupling member 702 further includes a rib 740 disposed between the boss region 738 and each resilient tab 706 and extending laterally across the coupling member. Each rib 740 and a respective side of the boss region 738 define a lateral channel 742 across the upper surface of the coupling member.

When the coupling member 702 is urged through and located centrally in the longitudinal channel 730 of the head engagement member 704, the central boss region 738 of the coupling member 702 locates in the correspondingly shaped and sized central aperture 733 of the head engagement member 704. Likewise, the bridge regions 732 of the head engagement member 704 each locate in a respective one of the lateral channels 742 of the coupling member 702. Alternatively, the lateral channels may be formed in the lower surface (forward-facing in use) of the coupling member for correspondingly sized regions, such as bridge regions, of the lower region of the engagement member to locate in. The head engagement member 704 is thereby longitudinally, and further laterally, constrained with respect to the coupling member 702, and vice versa. The enlarged end regions of the coupling member with respect to a width of the longitudinal channel 730 through the head engagement member 704 further longitudinally constrains the head engagement member 704 on the coupling member.

Desirably, the integration of a relatively stiff yet resilient plastics coupling member 702 with a relatively flexible yet resilient head engagement member 704 provides a rear-adjustable head strap assembly 700 that eliminates the need for ultrasonic welding, whilst allowing the two components to be separable for efficient mask maintenance and component recycling since compound or composite materials are avoided. Ultrasonic welding undesirably adds complexity to the manufacturing process and changes the geometry requirements of the components, which in turn adds material, and also prohibits the complete separation of the parts without damaging the mask.

Certain embodiments of the present invention therefore provide a system for coupling a harness strap to a respirator mask, wherein the system provides a limited amount of rotation of the strap, aptly around 65-85 degrees in one plane, with respect to the mask to allow some tolerance between the mask and the strap for adjustability and comfort, whilst preventing the straps becoming tangled or misaligned when the mask is not in use. The system allows a wearer to adjust each of the harness straps independently which provides a greater opportunity to fit the mask to the wearer in the most optimal position and orientation for that wearer to maximise comfort and user experience. The system according to certain embodiments of the present invention also provides for efficient coupling and decoupling of a harness strap to and from a respirator mask in a non-complex and efficient manner, particularly when wearing gloves and/or in relatively cold and/or wet environments.

1-22. (canceled)

23. A system for coupling a harness strap to a respirator mask, comprising:
a first coupling element attachable to a harness strap for securing a respirator mask to a wearer; and
a second coupling element fixed with respect to the respirator mask and configured to releasably engage with the first coupling element to couple the harness strap to the mask,
wherein the first coupling element is rotatable about an axis of the second coupling element and said rotation is limited by a stop arrangement.

24. The system according to claim 23, wherein said rotation is limited to 65-85 degrees.

25. The system according to claim 23, wherein the first coupling element comprises an aperture for receiving an elongate projecting element of the second coupling element.

26. The system according to claim 25, wherein the aperture comprises a receiving region for receiving an enlarged head portion of the projecting element and a locating region extending from the receiving region for locating an elongate body portion of the projecting element.

27. The system according to claim 26, wherein the locating region is configured to laterally constrain the first coupling element with respect to the projecting element whilst allowing the first coupling element to rotate with respect to the projecting element.

28. The system according to claim 27, wherein the locating region and a cross section of the elongate body portion of the projecting element are substantially circular and have substantially equal diameters to allow for said rotation whilst constraining the same laterally.

29. The system according to claim 28, wherein a width of an opening into the locating region from the receiving region is less than the diameter of the elongate body portion of the projecting element to provide a snap-fit coupling mechanism between the first coupling element and the second coupling element.

30. The system according to claim 26, wherein the head portion comprises an inclined upper surface.

31. The system according to claim 30, wherein a forward region of an under surface of the head portion is oriented substantially parallel with the inclined upper surface.

32. The system according to claim 31, wherein a rear region of the under surface is oriented substantially parallel with a bearing surface from which the projecting element perpendicularly extends.

33. The system according to claim 32, wherein a thickness of the first coupling element substantially equals a distance between the rear region of the under surface of the head portion and the bearing surface.

34. The system according to claim 26, wherein the receiving region of the aperture is substantially trapezoidal in symmetrical profile and tapers inwardly towards the locating region.

35. The system according to claim 34, wherein the receiving region has a width substantially equal to a width of the head portion.

36. The system according to claim 23, wherein the stop arrangement comprises an arcuate recess defining a stop surface at each opposed end thereof, and a stop portion moveable along the recess and engageable with each stop surface responsive to a direction of rotation of the first coupling element.

37. The system according to claim 36, wherein the first coupling element comprises the recess and the stop portion comprises a projection fixed with respect to the respirator mask.

38. A respirator mask comprising the system according to claim 23 and at least one harness strap for securing the mask to a wearer.

39. The mask according to claim 38, comprising a valve cover assembly removably mounted over an exhalation valve of the mask and comprising the second coupling element of the system.

40. The mask according to claim 39, wherein the valve cover assembly comprises the second coupling element at each of four corner regions thereof, and the at least one harness strap comprises a head strap assembly connected or connectable to an upper pair of the second coupling elements and a neck strap assembly connected or connectable to a lower pair of the second coupling elements.

41. The mask according to claim 39, wherein the valve cover assembly comprises a full-face lens and a substantially flexible sealing portion extending around an outer edge region of the lens for sealing engagement with a wearer's face and comprising the second coupling element.

42. The mask according to claim 41, wherein the second coupling element extends away from the lens from each of five spaced apart locations around the sealing portion comprising a pair of upper side locations, a pair of lower side locations, and an upper location disposed substantially on a sagittal plane of the mask.
